(19) United States
(12) Patent Application Publication
(10) Pub. No.: US 2026/0108339 A1
(43) Pub. Date: Apr. 23, 2026

(54) FIXED DENTAL APPLIANCE FOR CONTROLLED DRUG DELIVERY

(71) Applicant: LightForce Orthodontics, Inc., Burlington, MA (US)

(72) Inventor: Andrew Golden, Boston, MA (US)

(73) Assignee: LightForce Orthodontics, Inc., Burlington, MA (US)

(21) Appl. No.: 19/363,239

(22) Filed: Oct. 20, 2025

Related U.S. Application Data
(60) Provisional application No. 63/709,775, filed on Oct. 21, 2024.

(51) Int. Cl. A61C 19/06; A61C 7/14; B33Y 10/00

(52) U.S. Cl. CPC A61C 19/06; A61C 7/14; B33Y 10/00

(57) ABSTRACT

A drug delivery device may include a component with a bonding location to be bonded to a surface of one or more teeth. A cavity may hold a formulation that includes a compound, and an orifice may release the compound outside the component.

### RELATED APPLICATIONS

This Application also claims priority under 35 U.S.C. 119(e) to and is a Non-Provisional of U.S. Provisional Application Ser. No. 63/709,775, filed Oct. 21, 2024, entitled “FIXED DENTAL APPLIANCE FOR CONTROLLED DRUG DELIVERY”. The entire contents of this application is incorporated herein by reference in its entirety.

### FIELD

The present disclosure relates generally to fixed dental appliances. More specifically, the present disclosure relates to controlled drug delivery via fixed or bonded dental appliances.

### BACKGROUND

Oral drug delivery is the preferred method in many cases, but patient compliance with timing and dosage can be a factor in the efficacy of the treatment. Non-compliance may result from a wide range of causes including forgetfulness and unwillingness to be treated. Even when compliance is not an issue, some treatments may benefit from sustained drug delivery, which may also improve efficacy.

### SUMMARY OF THE DISCLOSURE

According to an exemplary embodiment, a drug delivery device includes a component that includes a bonding location to be bonded to a surface of one or more teeth. The component also includes a cavity to hold a formulation that includes a compound, and an orifice to release the compound outside the component.

According to another exemplary embodiment, a method of manufacturing a drug delivery system includes forming an orthodontic component to include a cavity to hold a formulation that includes a compound. The orthodontic component is to be bonded to one or more teeth. The method also includes forming the orthodontic component to include an orifice for the cavity to release the compound outside the orthodontic component.

It is noted that techniques for designing and implementing drug delivery via fixed dental appliances having various different features are disclosed herein and these features may be combined in various different configurations, including configurations not specifically illustrated or discussed. A person having ordinary skill in the art will realize that combinations not explicitly described herein are possible and enabled by the present disclosure and are within the scope of the present application. Additionally, although various techniques are disclosed herein for attaining the disclosed features, a person having ordinary skill in the art will realize that some modifications to the disclosed techniques may be possible and within the scope of the disclosed techniques. It is also to be understood that the phraseology and terminology employed herein are for the purpose of description and should not be regarded as limiting.

### BRIEF DESCRIPTION OF FIGURES

Various aspects, techniques, and embodiments of the present technology disclosed herein are described below with reference to the accompanying drawings. It should be appreciated that the figures are not necessarily drawn to scale. Items appearing in multiple figures may be indicated by the same reference numeral. For purposes of clarity, not every component may be labeled in every figure. Features of the present technology will become more apparent, and techniques for how to attain the features of the present technology, will be better understood by reference to the following detailed description considered in conjunction with the accompanying drawings, wherein:

FIG. 1 illustrates exemplary fixed dental appliances that may be used for controlled and sustained drug delivery according to one or more embodiments.

FIG. 2 is a side view of an exemplary tube as a fixed dental appliance used for drug delivery according to some embodiments.

FIG. 3A is a top-down view of the exemplary cavity according to the orientation shown in FIG. 2.

FIG. 3B is a side view of the exemplary cavity, as indicated in the side view of the exemplary tube in FIG. 2.

FIG. 4 is a side view of an exemplary bracket as a fixed dental appliance used for drug delivery according to some embodiments.

FIG. 5A is a top-down view of the exemplary cavity according to the orientation shown in FIG. 4.

FIG. 5B is a side view of the exemplary cavity, as indicated in the side view of the exemplary bracket in FIG. 4.

FIG. 6 illustrates a pontic as an exemplary fixed dental appliance used for drug delivery according to one or more embodiments.

FIG. 7 illustrates a bite turbo, which is a bite opening device (BOD), as an exemplary fixed dental appliance used for drug delivery according to one or more embodiments.

FIG. 8 is a process flow of an exemplary method of manufacturing and assembling a fixed dental appliance for drug delivery according to one or more embodiments.

FIG. 9 is a block diagram of an exemplary appliance manufacturing system including an additive manufacturing system to construct a fixed dental appliance according to one or more embodiments.

### DETAILED DESCRIPTION

Provided herein are exemplary implementations of providing controlled drug delivery via a cavity and associated opening(s) in a fixed dental appliance. The controlled drug delivery can include control of dosage and duration of the delivery, for example. The fixed dental appliance may be customized and may be produced as a single structure via additive manufacturing, for example, three-dimensional (3D) printing. The binding matrix of the appliance may be cross-linked (e.g., via ultraviolet (UV) cross-linking) in a layer-by-layer sequence. That is, the layers of binding agent printed by the 3D printer may be subjected to a process of chemically joining the layers to form the single structure. The fixed dental appliance may be produced as one or more components, such as a single component, two or more components (e.g., injection molded container and lid) that are bonded together, and/or the like.

As noted, oral drug delivery may be a preferred approach to treatment but may be negatively affected by patient non-compliance, whether that non-compliance is intentional or unintentional. In addition, sustained drug delivery and/or localized drug delivery may be advantageous to other drug delivery approaches. Localized drug delivery may reduce side effects and/or improve efficacy by providing a high concentration of a drug where needed, and a lower concentration where not needed. Sustained drug delivery may improve performance by providing a consistent drug concentration within a therapeutic range (e.g., a therapeutic window), instead of pills or injections that provide periodic concentrations that fall within the therapeutic range. Prior approaches to sustained oral drug delivery include mouthguards and patches with microneedles, but these approaches do not address both sustained delivery and compliance. In addition, control of dosage and duration is not addressed by the prior approaches. Further, these approaches do not take advantage of, when it is possible, fixed dental appliances that the patient may already need to wear for other treatments (e.g., for orthodontic treatments).

The inventors have recognized and appreciated the need to provide fixed dental appliances to provide controlled and sustained oral drug delivery. The inventors have developed techniques to design and manufacture such fixed dental appliances.

In some embodiments, the inventors have appreciated that a fixed dental appliance may be designed with a cavity to accommodate a formulation including a compound (e.g., the drug or therapeutic for delivery) to be released in a controlled and sustained manner. A therapeutic may be, for example, a small or large molecule drug compound, polymer or non-polymer, and biologic (e.g., protein, glycosaminoglycan (GAG), virus) or non-biologic. A fixed dental appliance refers to one that may be bonded (e.g., to a patient's tooth or teeth, directly or via a dental primer) or otherwise fixed within a patient's mouth rather than being easily removable like, for example, a mouthguard. Exemplary fixed dental appliances include brackets, tubes, bite turbos, and pontics. As such, for some patients, existing and/or otherwise required dental appliances (e.g., for an orthodontic treatment) can be additionally manufactured and used to provide controlled drug delivery, which thus avoids the need to use additional devices to treat the patient (e.g., separate patches and/or mouthguards). The volume of the cavity, the number of channels leading to orifices for release of the compound, and the dimensions of the channels may be among the features that are adjusted based on a specific formulation, desired dosage of the compound, and other drug delivery considerations. Additionally, placement and/or geometry of the cavity and channels may be adjusted to maintain mechanical strength of the fixed dental appliance, to prevent obstruction (e.g., of wires or bands for braces), and to ensure release of the compound at one or more particular locations within the mouth.

In some embodiments, the formulation may be designed in consideration of the compound. The formulation may be designed via an in vitro model or an in vivo model. Design considerations may include protecting activity, stability, and/or shelf life of the compound before and after the fixed dental appliance is bonded or otherwise affixed within the mouth. The formulation may also be designed in consideration of enhanced delivery of the compound and reduction of infiltration into the cavity of bacteria, host enzymes (e.g., amylase, lysozyme, lipase), or other host biologics (or toothpaste) that may adversely affect the compound.

In this way, controlled localized and/or sustained oral drug delivery may be achieved, leading to freeing treatment from patient compliance, improving efficacy, and/or reducing side-effects.

Following below are more detailed descriptions of various concepts related to, and embodiments of, techniques described above. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

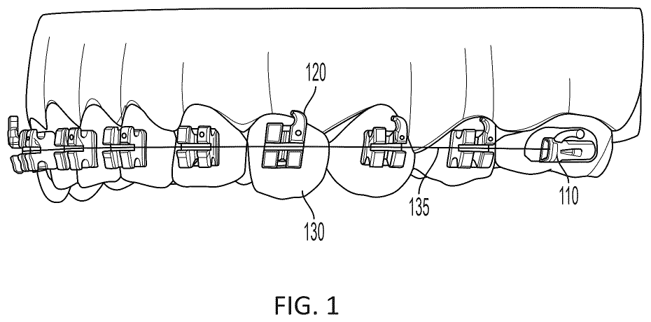

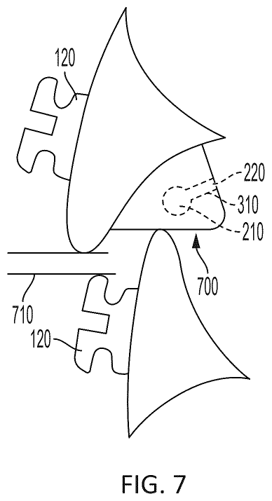

FIG. 1 illustrates exemplary fixed dental appliances 100 that may be used for controlled and sustained drug delivery according to one or more embodiments. A set of upper teeth is shown for illustrative purposes. The exemplary fixed dental appliances 100 shown in FIG. 1 includes a tube 110, bracket 120, and pontic 130. The tube 110 is a particular type of bracket that is typically bonded to back teeth. The illustrated examples do not limit the types of fixed dental appliances 100 that may be used for drug delivery. For example, a bite turbo 700 is discussed with reference to FIG. 7 as another exemplary fixed dental appliance 100 that can be used to provide controlled drug delivery.

A fixed dental appliance 100 may be generated by 3D printing, for example, which may simplify customization of the configuration and location of a cavity within the fixed dental appliance 100. The binding matrix of the printed fixed dental appliance 100 may be cross-linked (e.g., via UV cross-linking). Post-processing of a printed fixed dental appliance 100 may minimize cracking or other potential failure and may improve a color of the fixed dental appliance 100. Exemplary post-processing may include solvent evaporation, dehumidification, resin or binding agent evaporation, sintering, and/or hot isostatic pressing.

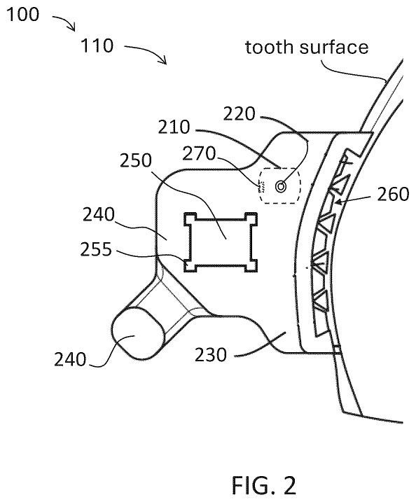

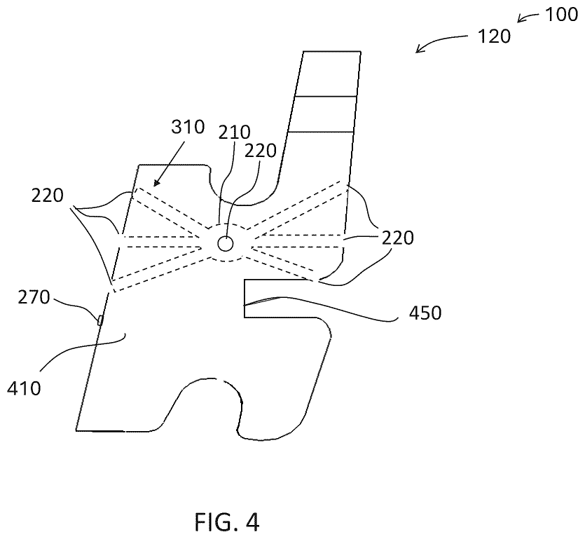

The material of the fixed dental appliance 100 may be affected by whether the fixed dental appliance 100 serves a function additional to drug delivery. For example, in the exemplary illustration in FIG. 1, an archwire 135 is shown that is received in a slot 250 (FIG. 2) of the tube 110 and a slot 450 (FIG. 4) of the bracket 120. The tube 110, bracket 120, and archwire 135, in conjunction with additional brackets, function as braces that align the teeth on which the brackets are bonded. The tube 110 and bracket 120 may be alumina, metal, zirconium, alloys, or other materials used for dental brackets. When the tube 110 or bracket 120 is 3D printed, the material may be present in the resin as microparticles, nanoparticles, aggregates of nanoparticles or microparticles, or the like.

In some embodiments, a fixed dental appliance 100 used for drug delivery need not also function to move teeth, for example. In this case, a broader range of 3D printed resins, including softer resins without alumina or metal particulate may be used. In addition, post-processing may be modified and some post-processing (e.g., resin evaporation, sintering, and/or hot isostatic pressing) may be avoided entirely. Cleaning of the 3D printed fixed dental appliance 100 may not change based on additional functionality. A chemical solvent may be used to eliminate resin or bonding matrix that is not cross-linked. The solvent may be applied in conjunction with heat and/or agitation for a prescribed time based on the post-processing that is performed. Application may involve a spray and air knife, a bath and air dry, sequential washes, ultrasonic cleaning, immersion in a bath with or without agitation, spray-on coating of solvent, and other known procedures. Excess solvent may be evaporated, removed by air or physical means, or may be rinsed away.

The exemplary illustration in FIG. 1 shows multiple fixed dental appliances 100 that may include a cavity to hold a formulation and release a compound. This illustration is not intended to limit the numbers, arrangements, and combinations of drug delivery components that may be used for a given patient. In some embodiments, multiple drugs may be delivered via multiple fixed dental appliances 100. In other embodiments, a single fixed dental appliance 100 may be used to release one compound. In yet other embodiments, a single fixed dental appliance 100 may be used to release different compounds at different times. Any of the embodiments may involve a fixed dental appliance 100 that is bonded to or affixed with top or bottom teeth. Additionally, although not specifically discussed, features of a given fixed dental appliance 100 that pertain to an orthodontic purpose may also be included. For example, tubes 110 and brackets 120 may include trenches for adhesion to teeth (see e.g., retention elements 260, FIG. 2), break away features, tie wings, and other known features additional to the slots 250, 450. Additional examples and details are discussed with reference to FIGS. 2-7.

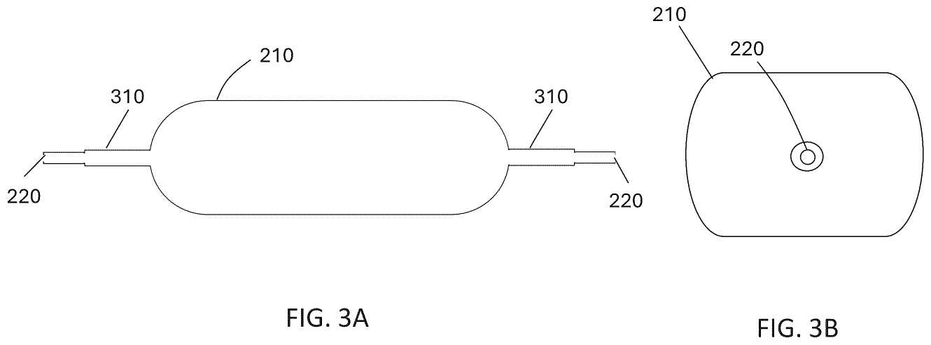

FIG. 2 is a side view of an exemplary tube 110 as a fixed dental appliance 100 used for drug delivery according to some embodiments. An exemplary cavity 210 and an orifice 220 to release a compound from the cavity 210 are indicated within the tube body 230. The tube 110 includes a hook 240 and a slot 250 with mortises 255 to receive an archwire 135. The tube 110 is also shown to include retention elements 260 to secure the tube 110 to a tooth surface. The configuration of the exemplary cavity 210 is further discussed with reference to FIGS. 3A and 3B.

FIG. 3A is a top-down view of the exemplary cavity 210 according to the orientation shown in FIG. 2. FIG. 3B is a side view of the exemplary cavity 210, as indicated in the side view of the exemplary tube 110 in FIG. 2. The cavity 210 has an oblong body and microfluidic channels 310 on each end of the body. While microfluidic channels 310 are discussed for explanatory purposes, the cavity 210 may additionally or alternatively have other channels, such as nanofluidic channels. The microfluidic channels 310 have an orifice 220 such that a compound may be released from the cavity 210 through the microfluidic channels 310 via the orifices 220. The exemplary microfluidic channels 310 are shown with a larger diameter leading out of the cavity 210 than leading to the orifice 220. The change in diameter along the microfluidic channels 310 may be one of the features used to control flow rate of the compound out of the cavity 210. Length of the microfluidic channels 310 and the size of the orifices 220 may also be designed to control drug delivery. While the exemplary cavity 210 is shown to have an oblong body, the cavity 210 may alternately have a circular cross-section or a different shaped cross-section or may not have a uniform cross-sectional shape along its length according to additional embodiments.

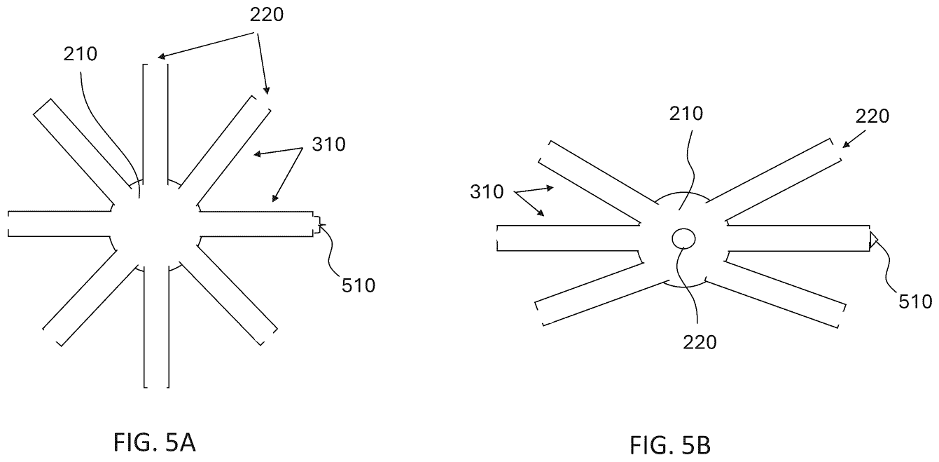

FIG. 4 is a side view of an exemplary bracket 120 as a fixed dental appliance 100 used for drug delivery according to some embodiments. The bracket 120 is shown to include a slot 450 for an archwire 135 and an exemplary cavity 210 within the bracket body 410. The microfluidic channels 310 and orifices 220 are indicated and further illustrated in FIGS. 5A and 5B.

FIG. 5A is a top-down view of the exemplary cavity 210 according to the orientation shown in FIG. 4. FIG. 5B is a side view of the exemplary cavity 210, as indicated in the side view of the exemplary bracket 120 in FIG. 4. In these views, one of the orifices is shown coupled to a sharp feature 510 (e.g., microneedle, abrasive feature). The non-smooth or sharp feature 510 may be in contact with the gingiva or mucosal lining to increase penetration and absorption of the compound. As noted with reference to FIGS. 3A and 3B, the exemplary illustration is not intended to limit variations and redesigns based on a number of potential factors. The geometry of the cavity 210 and one or more microfluidic channels 310 and orifices 220, as well as their location within a fixed dental appliance 100 may be designed in consideration of maintaining the mechanical integrity of the fixed dental appliance 100, avoiding other features (e.g., archwire 135), and/or directing release of a compound via one or more orifices 220 to a particular location within the mouth.

The geometry of the microfluidic channels 310, for example, may affect the retention of the matrix of the formulation that comprises the compound (e.g., ensuring that it does not fall out of the fixed dental appliance 100). The geometry may also affect concentration of the compound exiting the fixed dental appliance 100 and release of the compound, as well as location within the mouth where the compound will be released. For example, with an orifice 220 on a side of the bracket 210, the compound may leach or diffuse out of the bracket 210. With an orifice 220 at the base of the bracket 210, where it bonds to a tooth, the compound may diffuse into retention elements or trenches, then slowly release into the mouth through the dental adhesive that bonds the bracket 120 to the tooth. In exemplary embodiments, transmucosal drug delivery may be enhanced by a battery enclosed in the bracket 120 and an electrode coupled to the mouth, capable of iontophoresis.

In some embodiments, a sensor 270 with electronics and/or electrodes may be embedded within a cavity 210 (as shown in FIG. 2) or affixed to an outside of a fixed dental appliance 100 (as shown in FIG. 4). The sensor 270 may be similar to ingestible sensors currently employed in digital or smart pills, which transmit medical data after being consumed. Current digital pills may be used to monitor patients with tuberculosis or sleep apnea, for example. The sensor 270 employed in a cavity 210 or on a surface of a dental appliance 100 may facilitate monitoring similar data as smart pills and/or aspects of treatment compliance additional to drug consumption. For example, the sensor 270 may sense alcohol and may be used to monitor alcohol ingestion (e.g., when the compound should not be mixed with alcohol).

Based on the compound and the reason for its use, the target of the compound and, thus, the geometry and location of the cavity 210, microfluidic channels 310, and orifices 220 may vary. The drug may be directly transported (e.g., via diffusion) to teeth, tongue, gums, or other features within the mouth. In an exemplary embodiment, the target of the compound may be the gingival surface immediately adjacent to the fixed dental application 100 (e.g., to treat gingivitis). The compound may bind to the gingiva and diffuse into the tissue.

In other exemplary embodiments, the target of the compound may be the esophagus, stomach, bloodstream, or gastrointestinal system, for example. The compound, when released into the mouth, may be swallowed. The compound may go into the blood stream via the mucosa lining, for example. The sharp feature 510 coupled to one or more orifices 220 may facilitate submucosal injection in some embodiments. A combination of approaches or other known drug delivery vehicles may be used in conjunction with a fixed dental application 100 that has a cavity 210 holding a formulation that includes a compound.

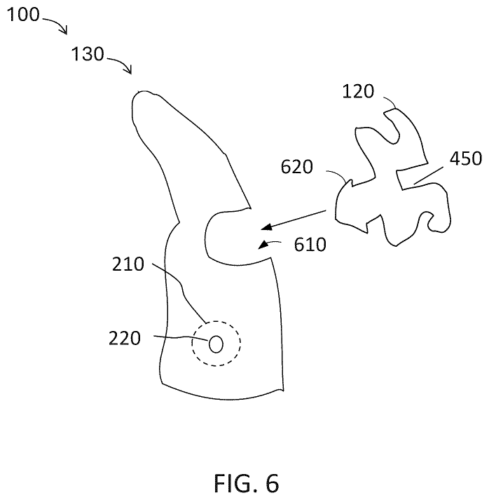

FIG. 6 illustrates a pontic 130 as an exemplary fixed dental appliance 100 used for drug delivery according to one or more embodiments. The exemplary pontic 130 is shown with an exemplary cavity 210 within and also includes an opening 610 that is sized to engage with a mating portion 620 of a bracket 120. Although the pontic may not include the opening 610 and may not engage with a bracket 120 according to alternate embodiments, the combination pontic 130 and bracket 120 may each include a different cavity 210 with the same or a different formulation and/or compound. For example, the combination of the pontic 130 and bracket 120, both with cavities 210, may be used to deliver two complementary compounds that may be more efficacious when taken together but at different rates.

FIG. 7 illustrates a bite turbo 700, which is a bite opening device (BOD), as an exemplary fixed dental appliance 100 used for drug delivery according to one or more embodiments. The bite turbo 700 is shown affixed to the back of a top tooth, and both the top and bottom teeth are shown with brackets 120 affixed to the front of the teeth. The bite turbo 700 results in a bite 710 or gap indicated in the figure and prevents the top tooth from contacting the bracket 120 of the bottom tooth. An exemplary cavity 210 with a microfluidic channel 310 leading to an orifice 220 is shown within the bite turbo 700.

Filling the cavity 210 of a fixed dental appliance 100 with a formulation including a compound may be accomplished in different ways. The cavity 210 of the fixed dental appliance 100 may be filled as part of the manufacturing process according to some embodiments. Alternately, a clinician may fill the cavity 210 with a formulation prior to bonding the bracket to a tooth of a patient. In some embodiments, the cavity 210 may initially be filled as part of the manufacturing process but may be refilled by a clinician. In other embodiments, an originally bonded bracket may be removed and replaced with another, freshly filled bracket (e.g., at a follow-up appointment). Prior to any filling of the cavity 210, the fixed dental appliance 100 may be sterilized to prevent biological growth on the formulation that may deteriorate the formulation or pose a risk to the patient. Sterilization may be part of the manufacturing process and/or the clinician's workflow at a bonding visit. Any known sterilization procedure may be used. For example, gamma irradiation, heat, or a 70 percent ethanol rinse and dry process may be used.

Filling the cavity 210 may involve immersing the fixed dental appliance 100 in a drug formulation bath, with or without ultrasonic agitation, according to some embodiments, such that air is evacuated from the cavity and replaced with the drug formulation. In other embodiments, the formulation may be injected into the cavity 210 via one or more orifices 220. In yet other embodiments, a droplet of the formulation may be placed at an orifice, and suction or capillary forces may be employed to pull the droplet into the cavity 210 via a microfluidic channel 310. Generally, any known approach to loading the drug formulation into the cavity may be employed. Cross-linking and/or polymerization may follow the filling according to some embodiments.

As previously noted, any combination of the filling processes and scenarios may be combined. For example, a clinician may obtain a fixed dental application 100 with the cavity 210 pre-filled with a formulation. The clinician may apply the fixed dental application 100 to a patient's tooth via any known process (e.g., direct or indirect bonding, with or without a primer, dental adhesive, UV light, or total energy). At a later time, the clinician may refill the cavity 210 with the same or a different formulation via injection, for example. The clinician may ensure that the cavity 210 is empty (e.g., by using a vacuum) prior to refilling.

As previously noted, the compound in a particular formulation may be for an orthodontic or dental condition (e.g., gingivitis, periodontitis) or may be prescribed for mental health, an infectious disease, eating disorder, cardiovascular or oncological condition, or any other non-orthodontic/dental condition. The particular condition or compound may influence the most efficacious delivery method and, thus, may affect the geometry and location of the cavity 210, microfluidic channels 310, and orifices 220, as well as any sharp features 510 or the number of brackets 120 or other appliances employed in drug delivery.

The formulation itself may be selected based on the compound of interest to protect activity, stability, and shelf life of the compound, facilitate release of the compound within a particular range of concentrations for a particular duration, to stay in the cavity 210 without falling out due to vibrations, impacts, or use of the fixed dental appliance 100, and to prevent damage to the fixed dental appliance 100. The formulation may include stabilizing components such as salts, BSA, HAS, PEG, PVA, and/or surfactants. Surfactants or nanoparticles may enhance delivery of the compound. The formulation may include additives such as thickeners, viscosifiers, hardening agents, flavor agents, and/or coloration. The formulation may include components that reduce infiltration of bacteria, host enzymes (e.g., amylase, lysozyme, lipase) or other biologics in the mouth that may deteriorate the formulation or reduce activity or stability of the compound. In vitro and/or in vivo models may be used to develop the formulation.

The compound itself is not intended to be limited by any example or discussion provided herein for explanatory purposes. A small molecule compound (e.g., molecular weight of approximately 500 Da), a protein or polymer therapeutic, nucleic acid-based therapeutic, antibiotic, hormone, vaccine, fluoride, appetite suppressant, cardiovascular medication, and/or any other medication or therapeutic may be used.

According to an exemplary embodiment, the formulation may comprise a polymer (e.g., hydrogel or gel). The polymer may be comprised of a biologic or synthetic (organic or inorganic) components. Examplary hydrogels include alginate, chitosan, extracellular matrix, matricel, polyethylene glycol, and polymer matrices (e.g., albumin, acrylic). The polymer matrix may be polymerized during the formulation process from monomeric components, or the formulation may use polymers. The hydrogel or polymer matrix may be crosslinked for stability (e.g., with glutaraldehyde, formaldehyde, genipin) or non-crosslinked.

According to an exemplary embodiment, a solvent for the hydrogel may be incorporated in the formulation. For example, an aqueous solvent with physiologically relevant salts (e.g., phosphate buffered saline, hank's solution, any known buffered solution) may be used. The compound may be incorporated or mixed into the hydrogel according to some embodiments. For example, biological cells capable of expressing or producing a drug may be incorporated into the hydrogel matrix. In this case, components that can sustain biological cells may also be incorporated into the formulation.

According to one or more embodiments, the formulation may be optimized to control the rate of diffusion of the drug compound. Rate of diffusion may be a function of factors such as the size or stokes radius of the compound, nonspecific binding or interactions of the compound with the hydrogel, and/or pore size and structure of the hydrogel. The diffusion may be optimized using one or a combination of known approaches such as, for example, selection of the hydrogel matrix, molecular weight range, cross-linker concentration, branching of the polymers, salts and their concentrations, and temperature of polymerization or crosslinking.

According to some embodiments, chemicals (e.g., fibronectin, silane chemistry) may be employed to enhance adhesion or inclusion of the bulk hydrogel within the cavity 210. In some embodiments, the cavity 210 may include features (e.g., surface roughness) or a tortuous geometry to prevent the formulation matrix from falling out of the fixed dental application 100, even in the event that shrinkage occurs after the drug formulation has been injected.

For example, if the cavity 210 and microfluidic channels 310 form a spider-like shape, as in FIGS. 5A and 5B, with a central cavity 210 region and eight microfluidic channels 310 exiting to eight separate orifices 220, then shrinkage may not lead to hydrogel loss because the hydrogel remains contained within the cavity 210. In some embodiments, the surface of the fabricated fixed dental appliance 100 may require activation so that the surface becomes hydrophilic. Activation may be via plasma treatment before treatment with surface chemistries, for example. In some embodiments, the formulation itself may comprise components that bind to the surface of the cavity 210 when positioned in contact with the surface.

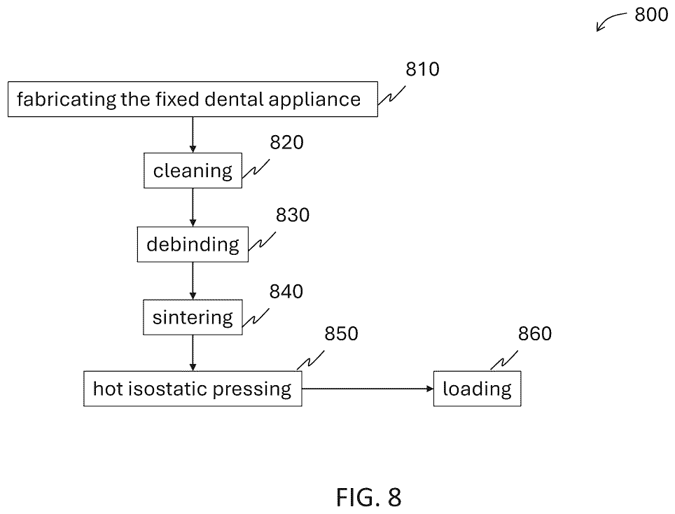

FIG. 8 is a process flow of an exemplary method 800 of manufacturing and assembling a fixed dental appliance 100 for drug delivery according to one or more embodiments. At 810, fabricating the fixed dental appliance 100 includes one or more of 3D printing, additive manufacturing, subtractive manufacturing, and molding. Fabricating may include forming one or more channels, such as microfluidic channels 310 and/or nanofluidic channels, for example. The fabrication at 810 may be followed by cleaning (e.g., removing uncross-linked resin, such as via use of a solvent), at 820, and debinding, at 830, to remove binding agents used in the 3D printing, for example. The debinding at 830 may involve evaporating binding agents (e.g., crosslinked resin) in an oven. At 840, sintering may be performed to bond a remaining particulate (e.g., non-evaporating particulate). This may involve heating the oven to a higher temperature than in debinding. At 850, an optional hot isostatic pressing (HIP) process (e.g., to increase density of the ceramic) may be implemented to improve color and/or reduce cracks.

Once the fixed dental appliance 100 with microfluidic channels 310 or nanofluidic channels is obtained according to 810-850, the loading process(es) at 860 may be performed as part of the manufacturing process or separately, such as by a clinician during a patient visit. At 860, loading refers to putting the formulation in the channels of the fixed dental appliance 100. The formulation may be manufactured in a sterile environment, and the loading, at 860, may be done with or without sterile handling.

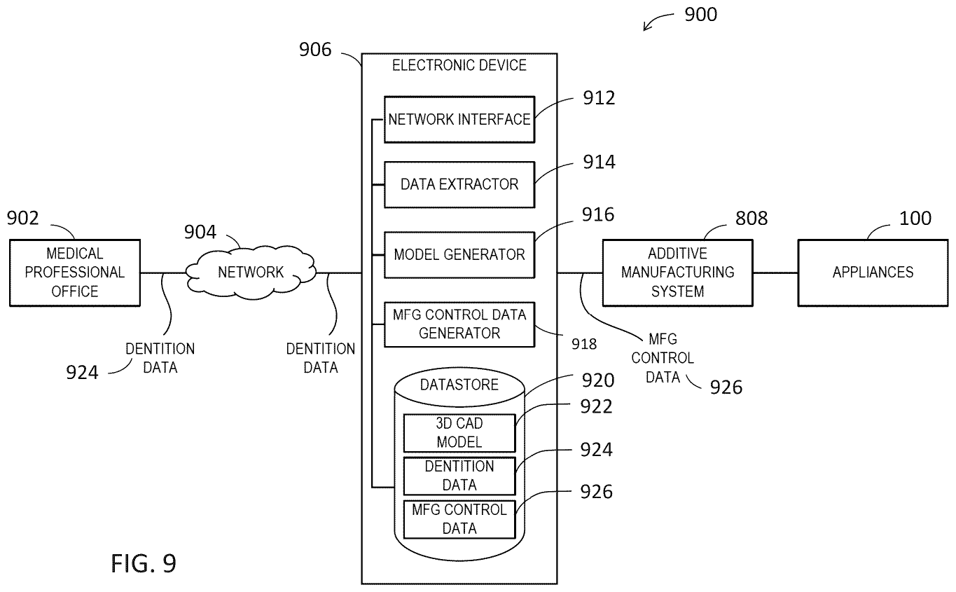

FIG. 9 is a block diagram of an appliance manufacturing system 900 including an additive manufacturing system 908 to construct a fixed dental appliance 100 according to one or more embodiments. Further depicted in FIG. 9 are a medical professional office 902, a network 904, and an electronic device 906. The electronic device 906 of this example includes and/or implements a network interface 912, a data extractor 914, a model generator 916, a manufacturing (MFG) control data generator 918, and a datastore 920, which includes, stores, and/or implements a 3D computer-assisted design (CAD) model 922.

According to some embodiments, measurement of dentition data 924 may be provided by the medical professional office 902 via the network 904 to the electronic device 906. The network 904 may be implemented by any wired and/or wireless network(s) such as one or more cellular networks, one or more local area networks (LANs), one or more optical fiber networks, one or more private networks, one or more public networks, one or more wireless local area networks (WLANs), etc., and/or any combination(s) thereof. For example, the network 904 may be the Internet, but any other type of private and/or public network is contemplated. The measurement may use computerized tomography (CT) layer scanning with a non-contact 3D scanner or an intra-oral scanner directly on the patient's teeth, or may use 3D readings on a teeth model previously cast or 3D printed using a coordinate measuring machine, a laser scanner, or structured light digitizers. The scanning accuracy of such techniques is typically less than about 0.02 millimeters (mm). Non-limited examples of the dentition data 924 include CT data, 3D reading data, a 3D model of a patient's mouth, coordinate measurement machine data, laser scanner data, and structured light digitizer data.

According to some embodiments, the electronic device 906 can be an electronic and/or computing system that causes manufacturing of the fixed dental appliance 100 based on the dentition data 924 via the additive manufacturing system 908. In some embodiments, the electronic device 906 can be associated with a designer, distributor, and/or manufacturer of the appliances 910. For example, the electronic device 906 can be a server (e.g., a computer server), a desktop computer, a laptop computer, a tablet computer, a computer workstation, etc., associated with an appliance manufacturer.

The electronic device 906 includes the network interface 912 to receive and/or obtain dentition data 924 from the network 904. The network interface 912 can store the dentition data 924 in the datastore 920. The electronic device 906 also includes the data extractor 914 to extract and/or identify data of interest from the dentition data 924 and the model generator 916 to construct and/or generate a model, such as a 3D CAD model, of a patient's mouth and/or teeth therein based on the dentition data 924. In some embodiments, the model generator 916 can store the model in the datastore 920 as the 3D CAD model 922. In some embodiments, the 3D CAD model 922 can be stored (e.g., saved) in a model file format. Non-limiting examples of a model file format include Standard Triangle Language or Standard Tessellation Language format (.stl) and additive manufacturing file (.amf) format.

The electronic device 906 includes the manufacturing control data generator 918 to process the 3D CAD model 922 to generate and/or output manufacturing control data 926 (identified by MFG control data) for use by the additive manufacturing system 908. For example, the manufacturing control data 926 can be commands, configuration data, instructions, etc., and/or any combination(s) thereof that cause (e.g., control, direct, instruct) the additive manufacturing system 908 to construct the appliances 910.

The additive manufacturing system 908 can perform and/or carry out one or more 3D printing processes, and/or, more generally, additive manufacturing processes, to generate the fixed dental appliance 100. Non-limiting examples of processes include ceramic slurry-based additive manufacturing technologies, such as digital light processing (DLP), laser photopolymerization stereolithography, jet printing (e.g., particle jetting, nanoparticle jetting), layer slurry depositioning (LSD), and laser-induced slip casting. For example, where the additive manufacturing system 908 implements a ceramic slurry-based additive manufacturing system, the additive manufacturing system 908 can be used to produce the fixed dental appliance 100 by slicing the 3D CAD model 922 (e.g., a 3D CAD bracket structure model) to separate it into thin layers and get the horizontal section model for each layer. Based on this section model, the additive manufacturing system 908 can directly produce the fixed dental appliance 100, ensuring the shape of each layer is consistent to the 3D CAD structure data. For example, the thickness of such layers may be about 20 micrometers or microns (μm) to about 50 μm with a manufacturing accuracy of about 5 μm to about 10 μm by using between-layer additive error compensation. In some embodiments, the additive manufacturing system 908 can be and/or implement a polymer based additive manufacturing system, and the polymer pontic(s) and/or orthodontic appliance(s) can be formed accordingly. In some such embodiments, post processing can involve cleaning, drying, and curing.

The electronic device 906 includes the datastore 920 to record data. Non-limiting examples of recorded data include the dentition data 924, the 3D CAD model 922, and the manufacturing control data 926. In some embodiments, the datastore 920 may be implemented by any technology for storing data. For example, the datastore 920 may be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 920 may additionally or alternatively be implemented by one or more double data rate (DDR) memories, such as DDR, DDR2, DDR3, DDR4, mobile DDR (mDDR), etc. The datastore 920 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 920 is illustrated as a single datastore, the datastore 920 may be implemented by any number and/or type(s) of datastores. Furthermore, the data stored in the datastore 920 may be in any data format. Non-limiting examples of data formats include a CAD model (e.g., a 3D CAD model), a flat file, binary data, comma delimited data, tab delimited data, and structured query language (SQL) structures.

While an example implementation of the electronic device 906, and/or, more generally, the appliance manufacturing system 900, is depicted in FIG. 9, other implementations are contemplated. For example, one or more blocks, components, functions, etc., of the electronic device 906 and/or the appliance manufacturing system 900 may be combined or divided in any other way. The electronic device 906 of the illustrated example may be implemented by hardware alone, or by a combination of hardware, software, and/or firmware. For example, the electronic device 906 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), etc.), one or more network interfaces (e.g., network interface circuitry, network interface cards (NICs), smart NICs, etc.), one or more ASICs, one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

FIG. 9 involves a non-limiting exemplary embodiment of a manufacturing system to construct a fixed dental appliance 100 according to some embodiments such as the exemplary embodiments discussed with reference to FIGS. 1-8. U.S. Pat. Nos. 11,872,101 and 12,070,369 are both incorporated herein by reference in their entirety for additional examples and details of the manufacturing process by which a fixed dental appliance 100 may be produced.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (e.g., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations. Furthermore, the advantages described above are not necessarily the only advantages, and it is not necessarily expected that all of the described advantages will be achieved with every embodiment.

What is claimed is:

1. A drug delivery device comprising a component that comprises:
a bonding location configured to be bonded to a surface of one or more teeth;
a cavity configured to hold a formulation that includes a compound; and
an orifice configured to release the compound outside the component.

2. The drug delivery device according to claim 1, wherein the component is an orthodontic bracket, an orthodontic tube comprising a slot configured to receive a portion of an archwire, or a bite turbo.

3. The drug delivery device according to claim 1, further comprising a sensor affixed to a surface of the component or other aspect of the drug delivery device.

4. The drug delivery device according to claim 1, further comprising a sensor embedded within the cavity.

5. The drug delivery device according to claim 1, wherein the component comprises a plurality of separate components, and one or more of the plurality of separate components comprise the cavity configured to hold the formulation.

6. The drug delivery device according to claim 5, wherein one or more other of the plurality of separate components are not configured to hold the compound.

7. The drug delivery device according to claim 1, wherein fabrication of the component comprises one or more of: three-dimensional printing, additive manufacturing, subtractive manufacturing, or molding.

8. The drug delivery device according to claim 1, wherein the component includes a micro or nano fluidic channel leading from the cavity to the orifice.

9. The drug delivery device according to claim 1, wherein the cavity and the orifice are configured to provide the compound outside the component as a localized treatment for an oral diagnosis or for a non-oral diagnosis.

10. The drug delivery device according to claim 1, wherein the orifice is coupled to a microneedle or abrasive feature to deliver the compound via submucosal injection.

11. A method of manufacturing a drug delivery system, the method comprising:
forming an orthodontic component to include a cavity configured to hold a formulation that includes a compound, wherein the orthodontic component is configured to be bonded to one or more teeth; and
forming the orthodontic component to include an orifice for the cavity configured to release the compound outside the orthodontic component.

12. The method according to claim 11, wherein forming the orthodontic appliance includes one or more of: three-dimensional (3D) printing, additive manufacturing, subtractive manufacturing, or molding.

13. The method according to claim 12, wherein forming the orthodontic appliance further includes debinding to remove binding agents used in the 3D printing and sintering to bond a remaining particulate.

14. The method according to claim 11, further comprising sterilizing the cavity and introducing the formulation that includes the compound into the cavity that has been sterilized.

15. The method according to claim 14, wherein the compound is a treatment for an oral diagnosis or a non-oral diagnosis.

16. The method according to claim 11, further comprising affixing a sensor to a surface of the orthodontic component or embedding the sensor within the cavity formed in the orthodontic component.

17. The method according to claim 11, wherein the orifice is sized based on a desired release rate or release duration for the compound.

18. The method according to claim 11, wherein forming the orthodontic component includes forming an orthodontic bracket, an orthodontic tube comprising a slot configured to receive a portion of an archwire, a pontic, or a bite turbo.

19. The method according to claim 11, wherein forming the orthodontic component includes forming a plurality of separate components and forming one or more of the plurality of separate components to include the cavity.

20. The method according to claim 11, further comprising coupling a microneedle or abrasive feature to the orifice.
